(19) United States
(12) Patent Application Publication
(10) Pub. No.: US 2015/0072333 A1
(43) Pub. Date: Mar. 12, 2015

(54) SYSTEM AND METHOD FOR PROVIDING A SECURE ONLINE TESTING ENVIRONMENT WITHOUT THE USE OF PASSWORDS

(71) Applicant: Vercom Software Inc., Dallas, TX (US)

(72) Inventor: Faisal BHOMBAL, ARLINGTON, TX (US)

(73) Assignee: Vercom Software Inc., Dallas, TX (US)

(21) Appl. No.: 14/151,067

(22) Filed: Jan. 9, 2014

Related U.S. Application Data
(60) Provisional application No. 61/876,826, filed on Sep. 12, 2013.

(51) Int. Cl. G09B 7/00

(52) U.S. Cl. CPC G09B 7/00
USPC 434/350; 434/362

(57) ABSTRACT

The disclosed embodiments include a method, apparatus, and computer program product for providing a secure online testing environment without the use of passwords. For example, one disclosed embodiment includes a computer-implemented method that performs, using one or more machines, operations that include receiving a warrant number corresponding to an exam through a teacher interface; retrieving the exam corresponding to the warrant number; generating an exam ID and an exam pin number; displaying the exam ID and the exam pin number on the teacher interface; receiving the exam ID through a student interface; requesting the exam pin number at the student interface; receiving the exam pin number through the student interface; and responsive to a determination that the exam pin number is valid, initiating the exam on the student interface.

### CROSS-REFERENCE TO RELATED APPLICATION

This application claims the benefit of U.S. Provisional Application 61/876,826, filed on Sep. 12, 2013, entitled “Formative Assessment Online Testing Dockets, which is incorporated herein by reference for all purposes.

### BACKGROUND OF THE INVENTION

The present invention generally relates to the field of providing online testing or assessment. Online assessment is the process used to measure certain aspects of information for a set purpose where the assessment is delivered via a computer connected to a network. Most often the assessment is some type of educational test. Assessments are a vital part of determining student achievement. However, online assessment is susceptible to academic dishonesty just as much, if not more than, traditional classroom assessment. Thus, current methods for providing online assessment typically require a student to be pre-registered and be assigned passwords for ensuring a secure testing environment.

### BRIEF SUMMARY OF THE INVENTION

The following description of the invention is intended to provide a brief summary of just one embodiment of the disclosed embodiments and is not intended to be exhaustive in its description or intended to limit the scope of the appended claims.

The disclosed embodiments include a method, apparatus, and computer program product for providing a secure online testing environment without the use of passwords and without requiring students to preregister for an exam. For example, one disclosed embodiment includes a computer-implemented method that performs, using one or more machines, operations that include receiving a warrant number corresponding to an exam through a teacher interface. As will be further described herein, the warrant number is a predetermined unique number assigned to each exam in the system. After receiving the warrant number, the method performs operations to retrieve the exam corresponding to the warrant number and generates an exam ID and an exam pin number. The method then displays the exam ID and the exam pin number on the teacher interface. The method further performs operations for receiving the exam ID through a student interface and then requesting the exam pin number at the student interface. Once the exam pin number is received through the student interface, the method performs operations for validating the exam pin number and initiating the exam on the student interface.

Additional embodiments, advantages, and novel features are set forth in the detailed description.

### BRIEF DESCRIPTION OF THE DRAWINGS

Illustrative embodiments of the present invention are described in detail below with reference to the attached drawing figures, which are incorporated by reference herein and wherein:

FIG. 1 is a schematic diagram illustrating a network environment in accordance with the disclosed embodiments;

FIG. 2 is a sequence diagram illustrating an example of a computer implemented method for providing a secure online testing environment without the use of passwords in accordance with one embodiment;

FIG. 3 illustrates an example of a teacher interface for entering a test warrant number in accordance with the disclosed embodiments;

FIG. 4 is an example of a testing curriculum having an assigned unique warrant number for each exam in accordance with the disclosed embodiments;

FIG. 5 illustrates an example of a teacher interface providing a test ID number and an exam pin number in accordance with the disclosed embodiments;

FIG. 6 illustrates an example of a student interface for entering a student ID and a test warrant number in accordance with the disclosed embodiments;

FIG. 7 illustrates an example of a teacher interface providing a status of students that have begun the log in process in accordance with the disclosed embodiments;

FIG. 8 illustrates an example of a student interface for entering a PIN number in accordance with the disclosed embodiments;

FIG. 9 illustrates an example of a student interface for taking an exam in accordance with the disclosed embodiments;

FIG. 10 illustrates an example of a teacher interface providing a status of students that are actively taking an exam in accordance with the disclosed embodiments;

FIG. 11 illustrates an example of a student interface for submitting an exam in accordance with the disclosed embodiments;

FIG. 12 illustrates an example of a teacher interface that provides the scores of an exam in accordance with the disclosed embodiments.

FIG. 13 is a flowchart illustrating an example of a computer implemented method for generating warrant numbers in accordance with the disclosed embodiments;

FIG. 14 is a flowchart illustrating an example of a computer implemented method for a performing a test login process for a teacher interface in accordance with the disclosed embodiments;

FIG. 15 is a flowchart illustrating an example of a computer implemented method for a performing a test login process for a student interface in accordance with the disclosed embodiments;

FIG. 16 is a flowchart illustrating an example of a computer implemented method for providing updated testing status during an exam in accordance with the disclosed embodiments; and

FIG. 17 is a block diagram illustrating one embodiment of a system for implementing the disclosed embodiments.

### DETAILED DESCRIPTION

As stated above, current methods for providing online assessment typically require a student to be pre-registered and be assigned or create passwords for ensuring a secure testing environment. However, in order to maintain a password for each individual user/student, a complex system for generating, maintaining, updating, and verifying passwords for possibly thousands of students must be implemented and maintained. Further, the preregistration process is time consuming and often one or more students will forget to pre-register. In addition, often one or more students will forget their passwords or have other issues with logging in to a testing environment.

Accordingly, the disclosed embodiments include a system, method, and computer program product that are designed to solve one or more of the above problems, while still providing a secure online testing environment without the use of passwords or the need for students to pre-register for an exam.

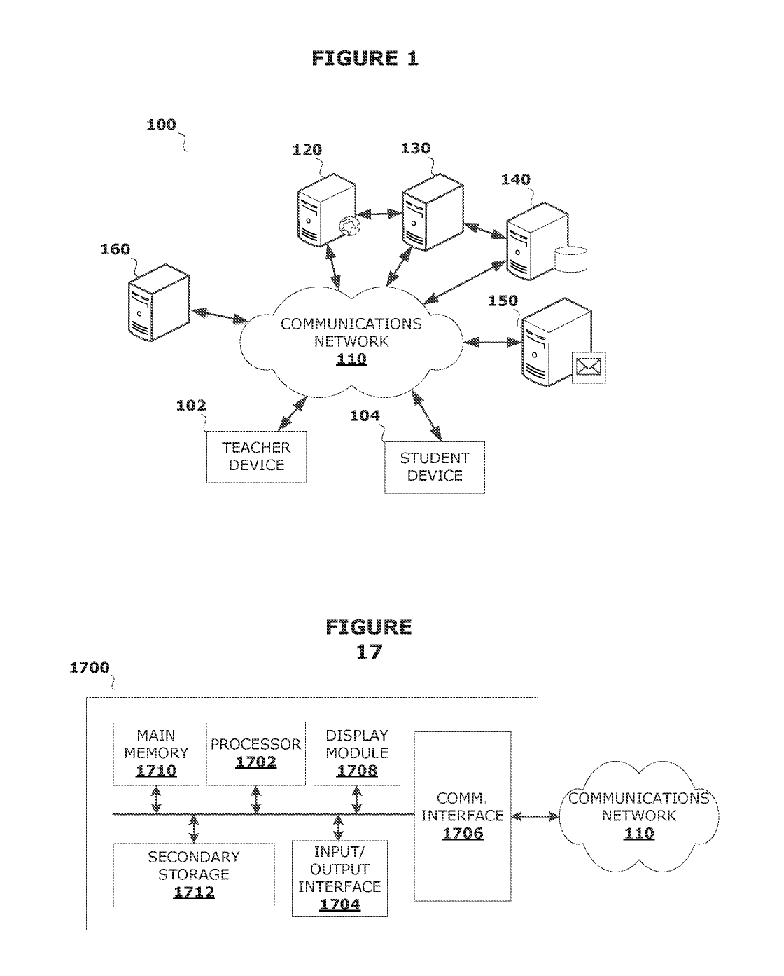

The disclosed embodiments and advantages thereof are best understood by referring to FIGS. 1-17 of the drawings, which are appended at the end of this document, like numerals being used for like and corresponding parts of the various drawings. The description of the present invention has been presented for purposes of illustration and description, but is not intended to be exhaustive or limited to the invention in the form disclosed. The embodiments were chosen and described to explain the principles of the invention and the practical application, and to enable others of ordinary skill in the art to understand the invention for various embodiments with various modifications as are suited to the particular use contemplated. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof.

In addition, as used herein, the term “teacher” refers to any person that is responsible for administering an exam and not necessarily limited to an instructor of a course. For example, the teacher device as referenced herein may be used by an exam proctor at a testing facility. Similarly, the term “student” refers to any person that is taking an exam and not necessarily limited to a student of a particular course. For example, the student device may be used by a teenager to take a driving test written exam, by a potential student taking an entrance exam, or by an employee of company that is taking a remedial training exam. Additionally, as used herein, the terms test and exam may be used interchangeably.

With reference now to FIG. 1, a network environment 100 is presented in which certain illustrative embodiments may be implemented. The network environment 100 includes a communications network 110 that enables a plurality of devices including, but not limited to, one or more teacher devices 102 and student devices 104 to communicate data with other devices connected to the communications network 110. The communications network 110 may be any type of network including a combination of one or more of the following networks: a wide area network, a local area network, one or more private networks, the Internet, a telephone network such as the public switched telephone network (PSTN), and one or more cellular networks or wireless data networks. The communications network 110 may include a plurality of network nodes (not depicted) such as routers, network access points/gateways, switches, DNS servers, proxy servers, and other network nodes for assisting in routing of data/communications between devices.

The teacher device 102 and the student device 104 may be any type of device that is operable to communicate with one or more servers over the communications network 110. For example, the teacher device 102 and/or the student device 104 may be a laptop computer, a mobile phone or tablet, a desktop computer, or any other device operable to communicate with the one or more servers over the communications network 110 for enabling a user to perform the features and functions of the disclosed embodiments. In accordance with the disclosed embodiments, the teacher device 102 and the student device 104 may be different types of devices. For example, in one scenario, the teacher device 102 is a desktop computer, while the student device 104 is a tablet computing device.

In one embodiment, the one or more servers may include one or more web servers 120, back-end servers 130, database servers 140, and mail servers 150. For example, in one embodiment, a user using a web browser application installed on the teacher device 102 interacts with a web site hosted by a web server 120 in order to initiate/give an exam. Alternatively, or in addition to, the teacher device 102 may be configured to interact with either the Web server 120 or directly with another server device via an application (e.g., a mobile app) installed on the teacher device 102 that is specially configured to perform the features and functions of the disclosed embodiments for enabling a teacher to give an exam.

Similarly, the student device 104 may utilize a web browser application to enable a student to interact with a web site hosted by a web server 120 for taking an exam. Alternatively, or in addition to, the student device 104 may have an application (e.g., a mobile student exam test taking app for a smartphone or tablet device) installed on the student device 104 that is specially configured to perform the features and functions of the disclosed embodiments for enabling a student to take an exam.

In one embodiment, the web server 120 may be configured to communicate with a back-end server 130 and a database server 140 for performing the features and functions of the disclosed embodiments for providing a secure online testing environment without the use of passwords. For example, back-end server 130 may perform the verification routines for verifying an test ID or pin number as will be further described herein. In certain embodiments, the back-end server 130 may also be responsible for querying the database server 140 for an exam, student profile information, and exam answers. Advantages of this network configuration is that it enables the back-end server 130 to serve multiple web servers 120, plus it provides for easier code management by splitting the interface code of the web server 120 from the labor intensive code of the back-end server 130. Moreover, the back-end server 130 generally has faster processing capabilities than that of the web server 120.

In some embodiments, the web servers 120, back-end servers 130, and database servers 140 may communicate with each other over the communications network 110. This communication may be over the Internet and/or over a private network. Alternatively, in some embodiments, one or more of the above server devices may be directly wired or networked to each other to provide direct communications between the devices. Still, in some embodiments, a single server/device may be configured to perform all of the features and functions of the disclosed embodiments.

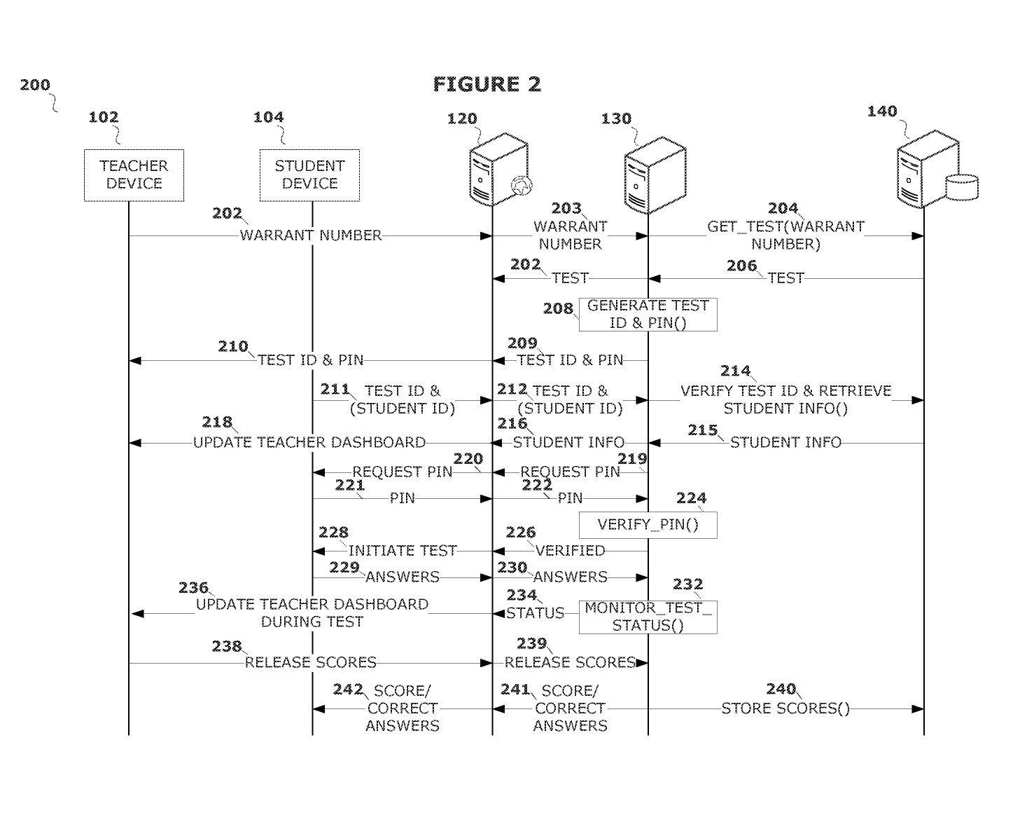

For instance, with reference now to FIG. 2, a sequence diagram 200 is presented in accordance with one embodiment. In the depicted embodiment, a separate web server 120, back-end server 130, and database server 140 are utilized for a providing a secure online testing environment without the use of passwords. The sequence diagram 200 illustrates an example of the sequence of instructions between the teacher device 102, the student device 104, and the web server 120, back-end server 130, and database server 140.

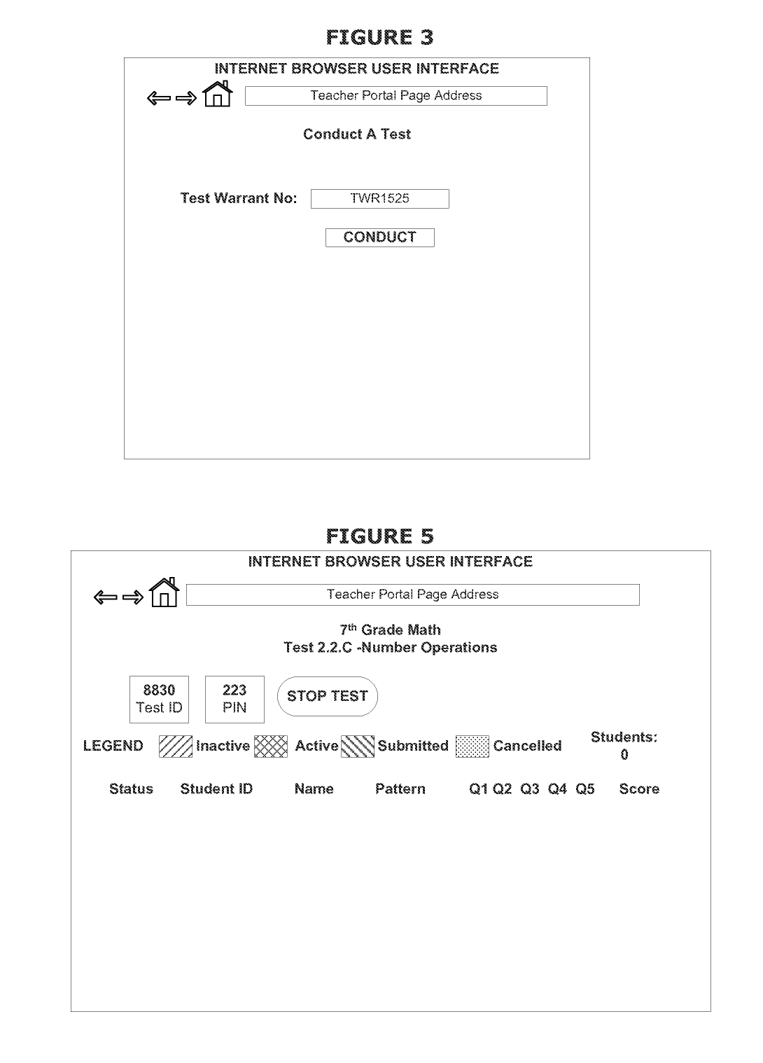

In this embodiment, the sequence diagram 200 begins with the teacher device 102 accessing a teacher web page hosted on the web server 120. In one embodiment, the teacher web page has a text field for enabling a teacher to enter a warrant number associated with an exam. An example of a teacher web page is illustrated in FIG. 3. In alternative embodiments, other methods for entering or selecting a warrant number may also be used such as, but not limited, selecting a warrant number from a list of available warrant numbers.

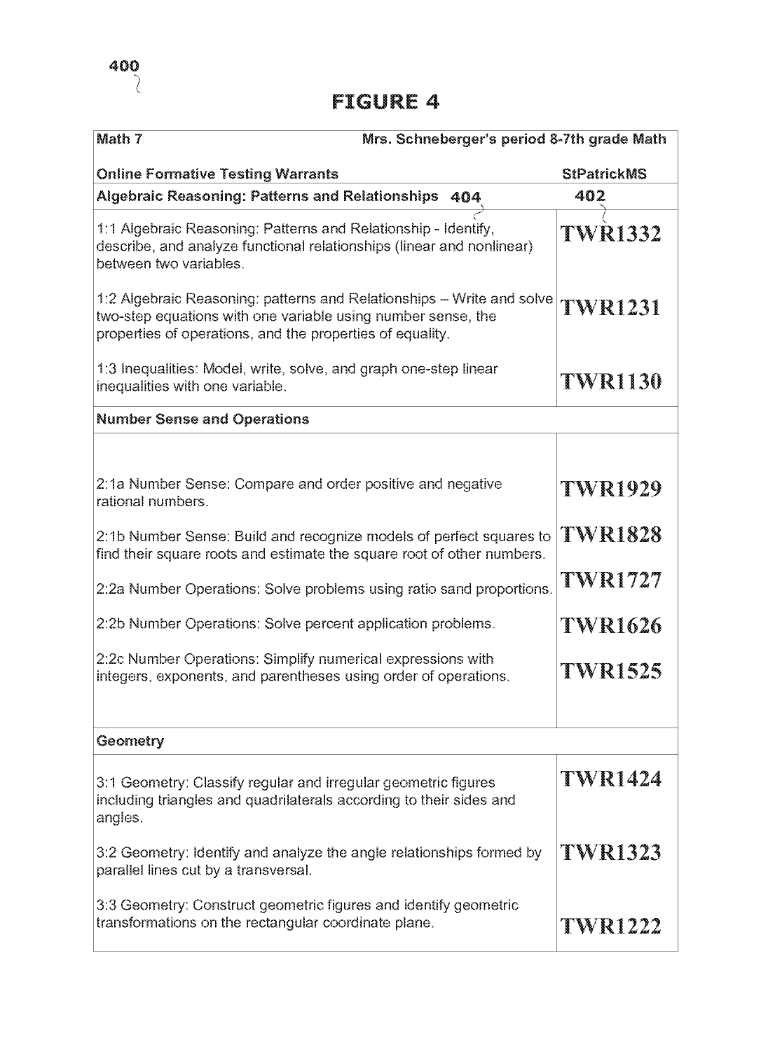

A warrant number as referenced herein is a unique number that is assigned to a particular exam. As will be further described, warrant numbers are generated and assigned to each active test that is stored by the disclosed system. In one embodiment, the warrant numbers are randomly generated. The warrant numbers corresponding to a list of exams are then distributed to the teachers associated with providing the exams. An example of warrant numbers 402 corresponding to a list of exams 404 for a testing curriculum 400 is illustrated in FIG. 4.

In the depicted embodiment, once the web server 120 receives the warrant number from the teacher device (sequence 202), the web server 120 sends the warrant number to the back-end server 130 (sequence 203) for verifying the warrant number. If the warrant number is verified, the back-end server 130 retrieves the exam data corresponding to the warrant number from the database server 140 (sequence 204). The exam data is passed from the database server 140 to the back-end server 130 (sequence 206), which in turn passes the exam data to the web server 120 (sequence 207) for enabling displaying of the exam questions to students taking the exam through a student web page interface as further described below.

The web server 120 also generates a test identifier (ID) and an exam PIN number (sequence 208). In certain embodiments, the test ID and the exam PIN number may be generated prior to retrieving the exam data. The back-end server 130 sends the test ID and the exam PIN number to the web server 120 (sequence 209) for enabling the web server 120 to update the teacher interface to display the test ID and the exam PIN number to a teacher (sequence 210). An example of a teacher interface that displays a test ID and an exam PIN number is illustrated in FIG. 5.

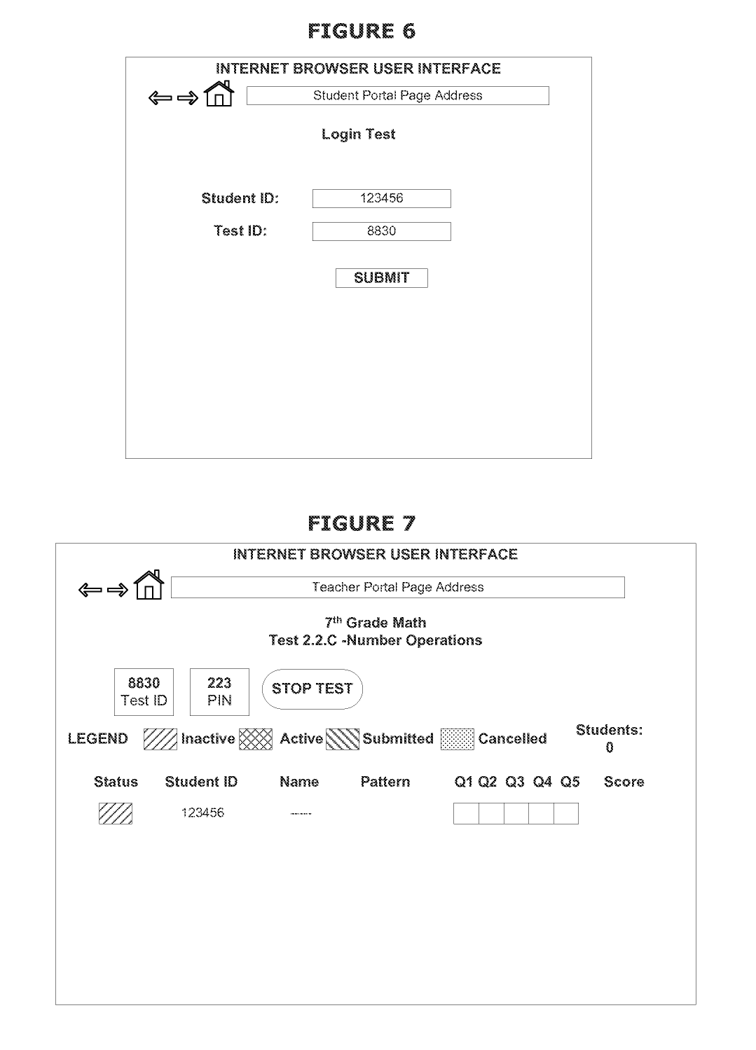

The teacher then tells the students that are taking the exam the test ID. This can be done verbally, written, or by any other form of communication. The students using the student device 104 then enters the test ID and optionally a student ID (sequence 211) at a student interface web page hosted by the web server 120 (or another web server) as illustrated in the example student interface web page shown in FIG. 6. The web server 120 passes the test ID and if available, the student ID to the back-end server 130 (sequence 212) for processing. The back-end server 130 verifies/authenticates the test ID and in certain embodiments, retrieves student information such as, but not limited to, a student name (sequence 214). If available, the student information is passed from the database server 140 to the back-end server 130 (sequence 215), and then passed to the web server 120 (sequence 216) for updating the teacher interface or also commonly referred to as a dashboard (sequence 218).

An example of an updated teacher interface/dashboard is illustrated in FIG. 7, which indicates the status of a student that has begun the login process. In the depicted embodiment, a student ID is listed along with a status indicator. In one embodiment, the status indicator may indicate one of four status: inactive, active, submitted, and cancelled. Inactive means that the student has initiated the login process, active means that the student has completed the login process and is taking the exam, submitted means that the student has completed and submitted the exam for scoring, and cancelled means that the test has been cancelled. In the depicted embodiment illustrated in FIG. 7, a dash line is depicted under the name of the student as the students name was either not available (e.g., no information on the student was previously stored in the database), not found (e.g., an invalid student ID was entered), or the student did not enter a student ID. In either case, in accordance with the disclosed embodiments, the student can still proceed to take the exam and the teacher can follow up and fill in the missing student's name.

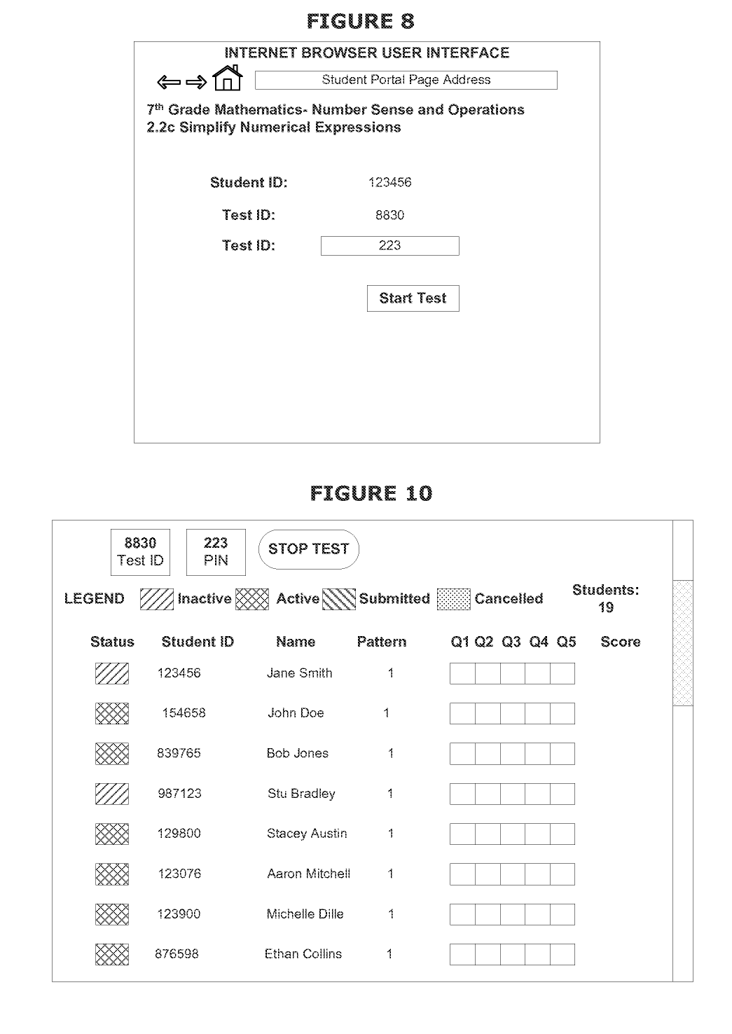

Referring back to FIG. 2, the back-end server 130 will also indicate to the web server 120 to update the student interface (sequence 219) to request an exam PIN number (sequence 220). For instance, in one embodiment, once the teacher is satisfied that all students taking the exam has initiated the login process (i.e., in an inactive state), the teacher will communicate to the students the exam PIN number. The students will then enter the exam PIN number into the student interface (sequence 221) as illustrated in the example shown in FIG. 8. The web server 120 passes the entered exam PIN number to the back-end server 130 (sequence 222), which verifies the exam PIN number (sequence 224). If the exam PIN number is correct, the back-end server 130 will provide an indication to the web server 120 that the exam PIN number has been verified (sequence 226). The web server 120 will then update the student interface to enable the student to begin taking the exam (sequence 228).

Although not illustrated in the sequence diagram, if the exam PIN number is not correct, the back-end server 130 will provide an indication to the web server 120 that the exam PIN number was not correct and the web server 120 will update the student interface to indicate that the entered exam PIN number was invalid and request the student to reenter the exam PIN number. In certain embodiments, after a predetermined number of times that an entered exam PIN number is found to be incorrect, the student may be locked out of the testing environment until a teacher releases the lock.

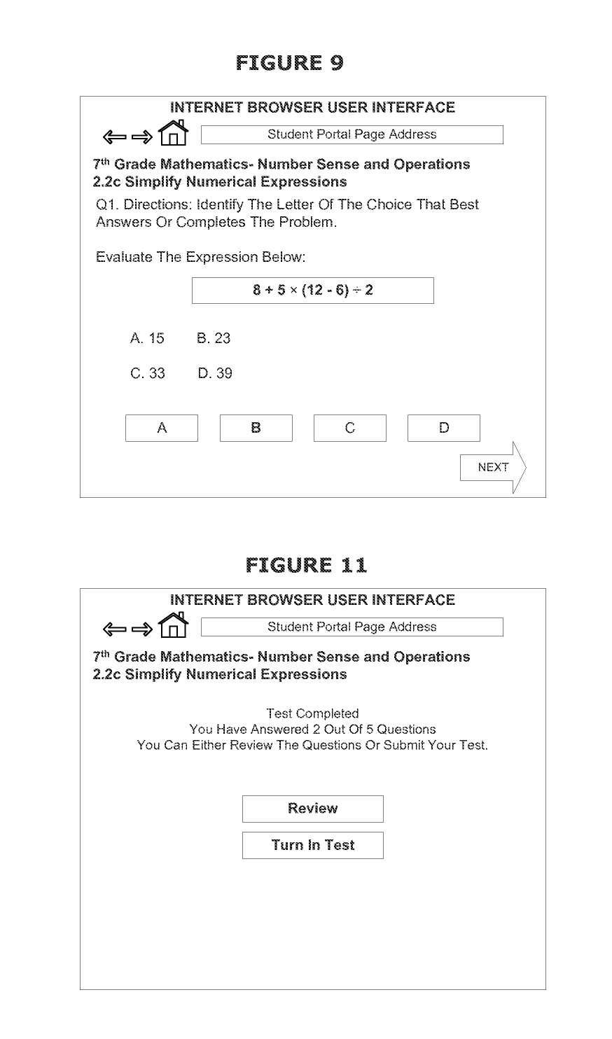

As indicated in the sequence diagram, the students using the student device 104 will provide or select answers to the exam using the student interface (sequence 229). An example of the student interface for providing exam questions and enabling a student to select an answer is illustrated in FIG. 9. In some embodiments, the student interface may also be configured to receive open ended answers, such as for fill in the blank type questions or essay type questions.

In one embodiment, the answers are passed to the back-end server 130 (sequence 230) after each answer is submitted for scoring the exam in near real-time (sequence 232). In alternative embodiments, the web server 120 may be configured to hold all answers until the exam is submitted by the student before passing the student answers to the back-end server 130 for scoring. In one embodiment, the status of the exam and/or real-time scoring information is passed from the back-end server 130 to the web server 120 (sequence 234) for updating the teacher dashboard during the exam (sequence 236) as shown in the given example illustrated in FIG. 10.

In one embodiment, as illustrated in FIG. 11, once the student has completed the exam or in certain embodiments, once an allotted exam time has expired, the student interface will provide the student with options to go back and review the questions/answers (option not available if the exam time has expired) and/or to turn in the exam.

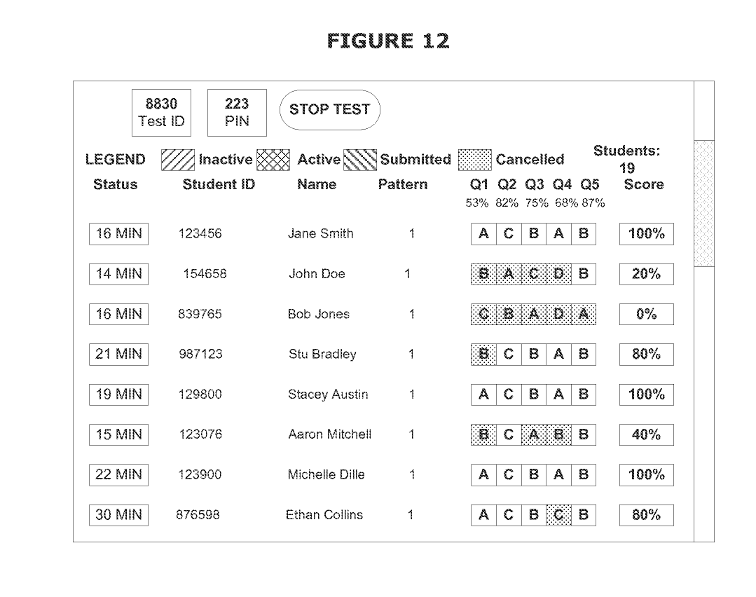

FIG. 12 illustrates another embodiment of the teacher interface/dashboard that provides the real-time or near real-time scoring for each of the exam takers. Once the teacher interface indicates that all the students have submitted their exams or once the allotted exam time has expired, the teacher can then release the scores to the students (sequence 238). The web server 120 passes that instruction onto the back-end server 130 (sequence 240). The back-end server 130 then passes the scoring information to the web server 120 (sequence 241) for enabling the web server 120 to update the respective student interfaces (sequence 242). In one embodiment, the back-end server 130 also updates/stores the student scores in the database server 140 (sequence 240), with the sequence diagram 200 terminating thereafter.

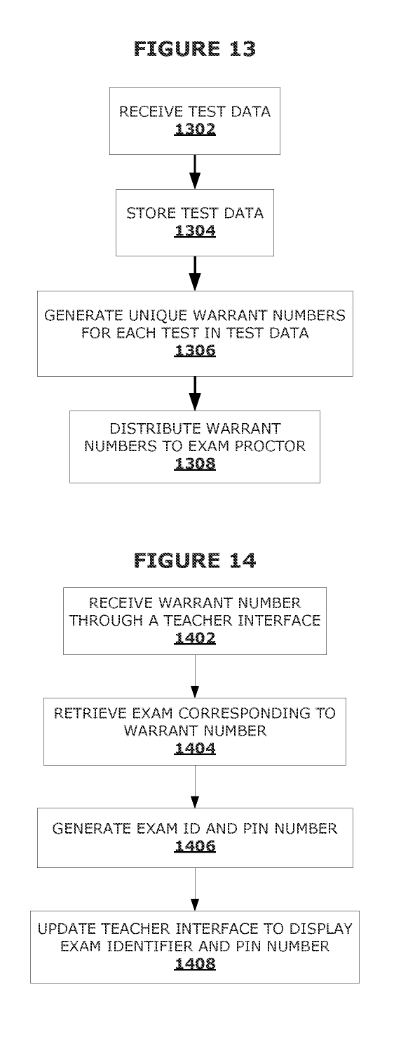

To further describe the inventions, several flow diagrams are illustrated in FIGS. 13-16 to provide additional details of the disclosed embodiments. The computer implemented methods described in FIGS. 13-16 may be implemented on one or more systems such as a web server, an application server, a back-end server, or any combination of systems.

For instance, starting with FIG. 13, a flowchart is presented illustrating an example of a computer implemented method 1300 for generating warrant numbers in accordance with the disclosed embodiments. The method begins at step 1302 by receiving test data such as a set of exams for a particular course or class. At step 1304, the test data is stored in a data repository such as a database. In certain embodiments, the test data may be stored without using a database and an appropriate searching algorithm for retrieving a desired test data may be implemented. Still, in certain embodiments, the test data may be processed prior to storage. For example, in some embodiments, information may be added to the test data to associate it with a particular class or teacher and/or the test data may be formatted or broken down into a particular format to enable displaying of a test.

The method at step 1306 then generates a unique set of warrant numbers, one for each test in the test data. A testing curriculum listing the exam names and corresponding warrant numbers may also be generated. Finally, at step 1308, the warrant numbers/testing curriculum is distributed to the teacher, exam proctor, or other appropriate personnel. In one embodiment, the method may electronically send the warrant numbers/testing curriculum to a teacher, exam proctor, testing facility, or other appropriate personnel (e.g., using email, fax, or other electronic messaging means). Alternatively, or in addition to, in certain embodiments, the system may be configured to send a hard copy of the warrant numbers/testing curriculum to a teacher or other appropriate personnel using regular mail or other physical delivery methods. The method 1300 for generating the warrant numbers terminates thereafter.

FIG. 14 is a flowchart illustrating an example of a computer implemented method 1400 for performing a test login process using a teacher interface in accordance with the disclosed embodiments. The method begins at step 1402 by receiving a warrant number at a teacher interface. The method at step 1404 verifies that the received warrant number is valid. If the received warrant number is invalid, the method indicates an error to the user on the teacher interface at step 1406 and return to step 1402. If the received warrant number is valid, the method at step 1408 will retrieve the exam data corresponding to the warrant number. The method generates an exam ID and exam PIN number at step 1410. The method updates the teacher interface to display the exam ID and exam PIN number at step 1412, with method 1400 terminating thereafter.

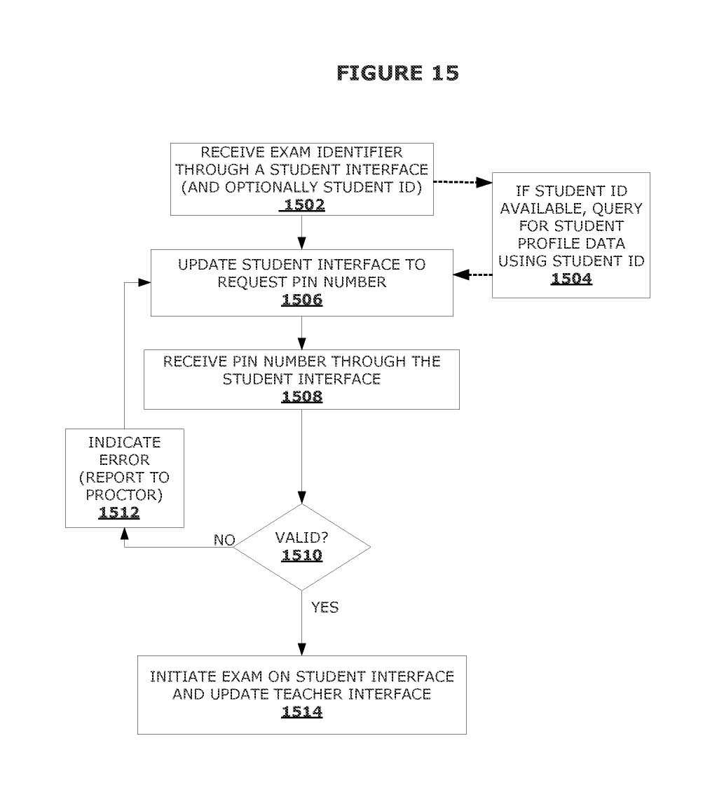

FIG. 15 is a flowchart illustrating an example of a computer implemented method 1500 for performing a test login process using a student interface in accordance with the disclosed embodiments. The method begins at step 1502 by receiving an exam ID at a student interface. In certain embodiments, the method may also be configured to receive a student ID. In such an embodiment, if a student ID is received, the method at step 1504, will perform a query or lookup for student profile data matching the received student ID. At step 1506, the method updates the student interface to request an exam PIN number. The method receives the exam PIN number at step 1508 and attempts to validate the exam PIN number at step 1510. If the exam PIN number is determined to be invalid, the method at step 1512 will indicate the error on the student interface and re-request the exam PIN number at step 1506. In certain embodiments, for security purposes, the method may optionally notify an exam proctor of an invalid exam PIN number entry and corresponding student information for enabling the exam proctor to assist the identified student, if needed, in entering the correct exam PIN number. If the exam PIN number is determined to be valid, the method at step 1514 initiates the exam on the student interface and updates the status of the student on the teacher interface, with method 1500 terminating thereafter.

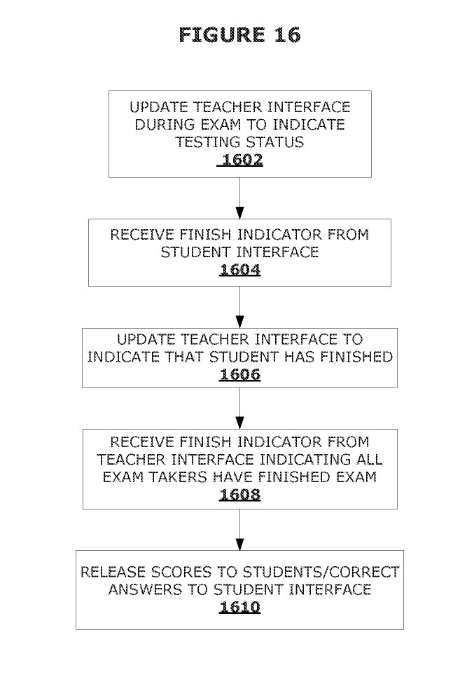

FIG. 16 is a flowchart illustrating an example of a computer implemented method 1600 for providing updated testing status during an exam in accordance with the disclosed embodiments. The method begins at step 1602 by updating the teacher interface or dashboard during the exam to indicate testing status of each test taker. In certain embodiments, the teacher device 102 may be configured to enable a teacher to monitor the status of exam takers for multiple exams (e.g., monitor the status of two different groups of students taking different exams). The testing status of a test taker is continuously updated in real-time or near-time during the exam until the method at step 1604 receives a finish indicator from a student interface indicating that the test taker has finished taking the exam. Once the finish indicator is received, the method at step 1606 updates the teacher interface to indicate that the particular test taker/student as finished his exam. Once all students have finished their exams, or after an allotted exam time has elapsed, or at a teacher's discretion, the method at step 1608 receives a finish indicator from the teacher interface. In response to receiving the finish indicator, the method at step 1610 releases the scores to the students for enabling the students to view their scores on the exam on the student interface. In certain embodiments, the method will also enable the students to review the wrong and correct answers to the exam using the student interface. The method 1600 terminates thereafter.

FIG. 17 illustrates a schematic diagram of an embodiment of a machine or system 1700 that may be utilized to perform the features and functions of the disclosed embodiments. The system 1700 includes a processor 1702, an input/output interface module 1704, a communication interface module 1706, main memory 1710, and secondary storage unit 1712. The processor 1702 may be any number of or type of processors capable of executing instructions for performing the features and functions of the disclosed embodiments.

The input/output interface module 1704 enables the system 1700 to receive user input and output information to a user or other devices. In some embodiments, the input/output interface module 1704 also provides audio and video capabilities. In certain embodiments, the input/output interface module 1704 may also enable external devices such as a printer, USB flash drive, and/or speakers to be connected to the system 1700.

The communication interface module 1706 enables the system 1700 to communicate with the communications network 110. For example, the communication interface module 1706 may include a network interface card for hardwiring the system 1700 to the communications network 110. In one embodiment, the communication interface module 1706 may also include a wireless data interface for enabling the system 1700 to communicate wirelessly through a wireless access point or via a wireless network within the communications network 110.

In some embodiments, the system 1700 may optionally include a display module 1708 to enable information to be displayed on an internal or external display device. For instance, the display module 1708 may include instructions or hardware for providing touchscreen capabilities for receiving user input via the display device. In certain embodiments, the display module 1708 may also include instructions for enabling multi-touch functionalities associated with a display device.

Main memory 1710 is volatile memory that stores currently executing instructions/data, or instructions/data that are prefetched for execution. The secondary storage unit 1712 is non-volatile memory for storing persistent data. The secondary storage unit 1712 may be or include any type of data storage component such as a hard drive, a flash drive, or a memory card. In one embodiment, the secondary storage unit 1712 stores the computer executable code/instructions and other relevant data for enabling a user to perform the features and functions of the disclosed embodiments. These instructions are passed from the secondary storage unit 1712 to main memory 1710 for enabling execution by the processor 1702. For example, as described further below, in accordance with the disclosed embodiments, the computer executable instructions may include, but not limited to, instructions for generating a user interface, for parsing information received from a user, for verifying an test identifier and an exam pin number, for retrieving an exam, monitoring a test status, and scoring an exam.

While specific details about the above embodiments have been described, the above hardware and software descriptions are intended merely as example embodiments and are not intended to limit the structure or implementation of the disclosed embodiments. For instance, although many other internal components of the system 1700 are not shown, those of ordinary skill in the art will appreciate that such components and their interconnection are well known.

Additionally, although the teacher interface and student interface are shown as web pages being displayed using a web browser application, the disclosed embodiments may be implemented as a specially designed program or application such as a mobile app that is installed on the respective teacher device and student device for enabling performance of the disclosed features. For instance, a mobile application may be designed to display similar graphical user interface as those presented in the figures without the use of a web browser application. In these embodiments, a teacher, using a teacher's version of the mobile Applicants, needs to simply start the mobile app and it will automatically communicate with the server application without the need for the teacher to open up and access a teacher interface web page/address. Similarly, a student, using the student's version of the mobile Applicants, will simply start the app and enter the required student information as described above without having to access a student interface web page/address.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While many specific example embodiments are described above, the above description is not intended to be exhaustive or limit the invention in the form disclosed. Many modifications and variations will be apparent to those of ordinary skill in the art without departing from the scope and spirit of the invention. The scope of the claims is intended to broadly cover the disclosed embodiments and any such modification.

1. A system comprising:
at least one processor; and
at least one memory coupled to the at least one processor and storing instructions that when executed by the at least one processor causes one or more machines to perform operations comprising:
receiving a warrant number corresponding to an exam through a teacher interface;
retrieving the exam corresponding to the warrant number;
generating an exam ID and an exam pin number;
displaying the exam ID and the exam pin number on the teacher interface.

2. The system of claim 1, wherein the teacher interface is a web page displayed using a web browser application.

3. The system of claim 1, wherein the teacher interface is a specially designed application installed on a teacher device for displaying the teacher interface.

4. The system of claim 3, wherein the operations further comprise:
receiving the exam ID through a student interface;
requesting the exam pin number at the student interface;
receiving the exam pin number through the student interface;
validating the exam pin number;
responsive to a determination that the exam pin number is valid, initiating the exam on the student interface; and
updating the teacher interface to indicate a testing status of students taking the exam.

5. The system of claim 4, wherein the operations further comprise:
receiving a student ID through a student interface;
retrieving student information using the student ID; and
displaying the student information on the teacher interface.

6. The system of claim 4, wherein the operations further comprise:
updating the teacher interface to indicate an updated testing status of students taking the exam while the exam is being taken;
receiving a finish indicator from the student interface; and
updating the teacher interface to indicate that a student associated with the finish indicator has finished taking the exam.

7. The system of claim 6, wherein the operations further comprise:
receiving an all finish exam indicator from the teacher interface indicating all exam takers have finished taking the exam; and
responsive to receiving the all finish exam indicator from the teacher interface, releasing test scores to enable students to view their scores at the student interface.

8. The system of claim 6, wherein the operations further comprise updating the student information with a test score associated with the exam.

9. The system of claim 1, wherein the operations further comprise:
receiving test data, wherein the test data includes one or more exams;
storing the test data;
generating a unique warrant number for each of the one or more exams; and
distributing the unique warrant number for each of the one or more exams to a teacher associated with providing the exams.

10. A computer-implemented method for providing a secure online testing environment without the use of passwords comprising:
receiving a warrant number corresponding to an exam through a teacher interface;
retrieving the exam corresponding to the warrant number;
generating, using a processor, an exam ID and an exam pin number;
displaying the exam ID and the exam pin number on the teacher interface.

11. The computer-implemented method of claim 10, wherein the teacher interface is a web page displayed using a web browser application.

12. The computer-implemented method of claim 10, wherein the teacher interface is a specially designed application installed on a teacher device for displaying the teacher interface.

13. The computer-implemented method of claim 12, wherein the operations further comprise:
receiving the exam ID through a student interface;
requesting the exam pin number at the student interface;
receiving the exam pin number through the student interface;
validating the exam pin number;
responsive to a determination that the exam pin number is valid, initiating the exam on the student interface; and
updating the teacher interface to indicate a testing status of students taking the exam.

14. The computer-implemented method of claim 13, wherein the operations further comprise:
receiving a student ID through a student interface;
retrieving student information using the student ID; and
displaying the student information on the teacher interface.

15. The computer-implemented method of claim 13, wherein the operations further comprise:
updating the teacher interface to indicate an updated testing status of students taking the exam while the exam is being taken;
receiving a finish indicator from the student interface; and
updating the teacher interface to indicate that a student associated with the finish indicator has finished taking the exam.

16. The computer-implemented method of claim 15, wherein the operations further comprise:
receiving an all finish exam indicator from the teacher interface indicating all exam takers have finished taking the exam; and
responsive to receiving the all finish exam indicator from the teacher interface, releasing test scores to enable students to view their scores at the student interface.

17. The computer-implemented method of claim 15, wherein the operations further comprise updating the student information with a test score associated with the exam.

18. The computer-implemented method of claim 10, wherein the operations further comprise:
receiving test data, wherein the test data includes one or more exams;
storing the test data;
generating a unique warrant number for each of the one or more exams; and
distributing the unique warrant number for each of the one or more exams to a teacher associated with providing the exams.

19. A non-transitory computer readable medium comprising computer executable instructions for providing a secure online testing environment without the use of passwords, the computer executable instructions when executed causes one or more machines to perform operations comprising:
receiving a warrant number corresponding to an exam through a teacher interface;
retrieving the exam corresponding to the warrant number;
generating an exam ID and an exam pin number;
displaying the exam ID and the exam pin number on the teacher interface.

20. The non-transitory computer readable medium of claim 19, wherein the operations further comprise:
receiving the exam ID through a student interface;
requesting the exam pin number at the student interface;
receiving the exam pin number through the student interface;
validating the exam pin number;
responsive to a determination that the exam pin number is valid, initiating the exam on the student interface; and
updating the teacher interface to indicate a testing status of students taking the exam.
